(19) United States
(12) Patent Application Publication
(10) Pub. No.: US 2016/0026972 A1
(43) Pub. Date: Jan. 28, 2016

(54) Artificial Intelligence Enabled Mobile Lottery Tracking Application for Retail Businesses and Convenience Stores

(71) Applicant: Jipal P. Bhalodwala, Milledgeville, GA (US)

(72) Inventor: Jipal P. Bhalodwala, Milledgeville, GA (US)

(21) Appl. No.: 14/806,295

(22) Filed: Jul. 22, 2015

Related U.S. Application Data
(60) Provisional application No. 62/027,662, filed on Jul. 22, 2014.

(51) Int. Cl. G06Q 10/08; G06Q 40/00

(52) U.S. Cl. CPC G06Q 10/087; G06Q 40/12

(57) ABSTRACT

A method for tracking lottery sales information utilizes an unsold ticket count and a sold ticket count for a plurality of sequential-ordered lottery tickets. The unsold ticket count and the sold ticket count is continuously updated when a current work shift is closed. In order to close the current work shift, identification data from a first-remaining lottery ticket is received. The identification data is transferred through a scanning device. When the identification data is received, the unsold ticket count and the sold ticket count is updated accordingly. Next, the sold ticket count and the unsold ticket count are used to determine a sales sharing percentage and a space sharing percentage. Based on the space sharing percentage and the sales sharing percentage future orders for a plurality of ticket types are adjusted such that the overall profit of a store is maximized.

The current application claims a priority to the U.S. Provisional Patent application Ser. No. 62/027,662 filed on Jul. 22, 2014.

### FIELD OF THE INVENTION

The present invention relates generally to a tracking application. More specifically, the present invention introduces an application that is used to track sales of lottery tickets.

### BACKGROUND OF THE INVENTION

In the United States, lotteries are run by 47 jurisdictions (44 states plus the District of Columbia, Puerto Rico and the U.S. Virgin Islands). The lottery business is governed by and subject to the laws of each jurisdiction. Most states have several different lotteries including instant-win scratch-off games, daily games and games where one picks numbers. Even though a buyer can conveniently access and utilize a lottery ticket, managing a large number of lottery tickets can be a daunting task for a store owner.

A significant challenge faced by many store owners is the need to itemize lottery tickets into an inventory. Usually, the inventory is prepared by an employee of the store at the end of a shift. In doing so, the employee manually enters all relevant information. The procedure of manually entering data can be time consuming and also inefficient resulting in less productivity. The reduced productivity ultimately leads to reducing store profits.

With the traditional method of itemizing lottery tickets, the store owner has minimum knowledge of the lottery tickets with the highest demand. As a result, the store owner repeatedly purchases the lowest selling lottery ticket and the highest selling ticket with the same importance. In the long term, purchasing these low selling tickets can negatively impact the store owner.

On most occasions, store owners oversee activity of a store by being physically present at the store. Trust issues and the inefficiency of the employees are among the main reasons the store owner physically oversees certain activity. Physically being present at a store can be demanding when managing multiple stores. Therefore, the need to receive real time updates from a store is clearly evident. The present invention introduces a solution by providing real time updates on store activity.

The objective of the present invention is to address the aforementioned issues. In particular, the present invention eliminates the need to manually enter data regarding the lottery tickets available at the end of a shift. As a result, the store owner not only saves time but also cuts down on the costs related to labor. Since all inventory information is stored on a secure server, the store owner can conveniently access the information remotely and also receive real time updates regarding lottery sales. Therefore, the need to oversee each store location is eliminated. The predictions and analysis made through artificial intelligence helps the store owner understand the sales pattern of each lottery ticket. As a result, the store owner can invest in the highest selling tickets such that there is a higher return on investment.

### BRIEF DESCRIPTION OF THE DRAWINGS

FIG. 1 is a flowchart illustrating the basic overall process of the present invention.

FIG. 2 is a flowchart illustrating the basic overall process of selecting a sample-size time period and generating a profitability rank.

FIG. 3 is a flowchart illustrating the basic overall process of calculating the analytic difference from the sales sharing percentage and the space sharing percentage.

FIG. 4 is a flowchart illustrating the basic overall process of calculating the sales sharing percentage.

FIG. 5 is a flowchart illustrating the basic overall process of calculating the space sharing percentage.

FIG. 6 is a flowchart illustrating the basic overall process of determining the purchase rate by utilizing the analytic difference.

FIG. 7 is a flowchart illustrating the basic overall process of determining the most-profitable ticket types.

FIG. 8 is a flowchart illustrating the basic overall process of determining the future orders through the present invention.

FIG. 9 is a flowchart illustrating the basic overall process of enabling the employee account to submit identification data through the scanning device.

FIG. 10 is a flowchart illustrating the basic overall process of restocking and relocating lottery tickets through the manager account.

FIG. 11 is a flowchart illustrating the basic overall process of enabling the owner account to view store-wide sales data.

### DETAIL DESCRIPTIONS OF THE INVENTION

All illustrations of the drawings are for the purpose of describing selected versions of the present invention and are not intended to limit the scope of the present invention.

The present invention introduces a method of tracking the sales of lottery tickets. In particular, the present invention intends to eliminate the need of logging in sales information manually. As experienced by many individuals in the lottery ticket industry, the process of manually entering sales information and maintaining a sales log can be time consuming and also extremely stressful. As a result of the time consuming process and related labor, the overall productivity of a store declines over time. By utilizing the present invention, a store owner is guaranteed to maximize profits with time.

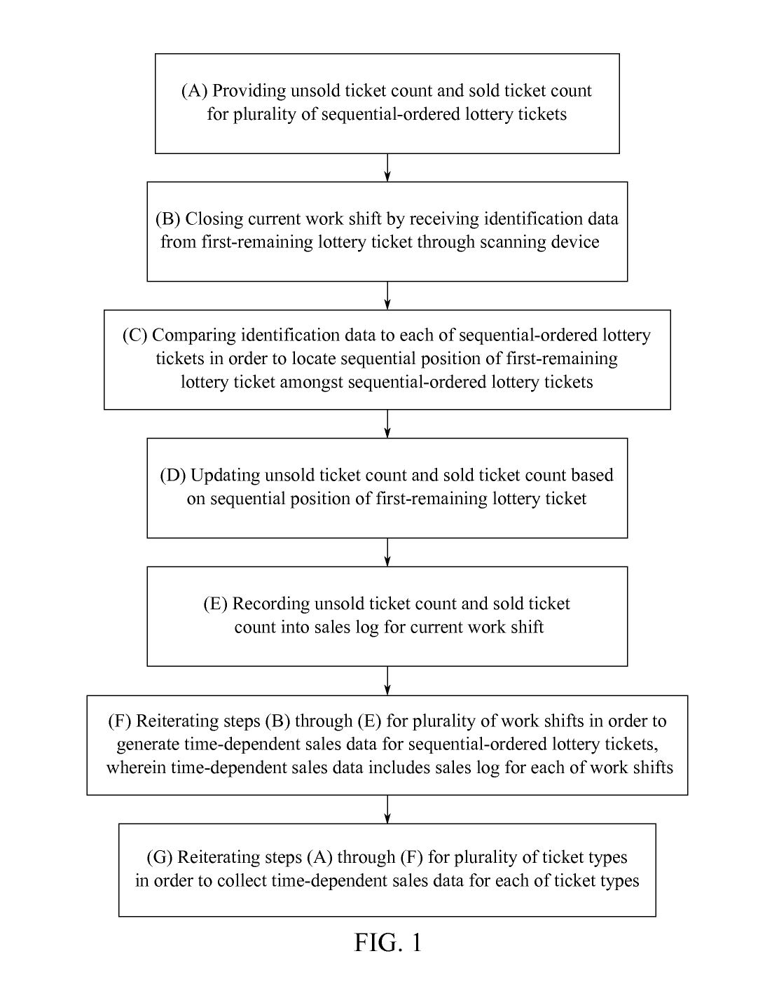

In order to monitor the sales of lottery tickets, the present invention maintains a digital log of the lottery tickets available in a store. As illustrated in FIG. 1, during an overall process of the present invention, an unsold ticket count and a sold ticket count is initially provided for a plurality of sequential-ordered lottery tickets of a particular store. In the preferred embodiment of the present invention, the plurality of sequential-ordered lottery tickets is a roll of lottery tickets. The sales of the lottery tickets and other related information is calculated utilizing the changes that occur to the unsold ticket count and the sold ticket count that was provided initially. In order to continuously monitor and update the unsold ticket count and the sold ticket count, the present invention receives identification data from a first-remaining lottery ticket by scanning through a scanning device. In the preferred embodiment, the first-remaining ticket is the first available ticket from the roll of lottery tickets at the end of a current working shift. The identification data is unique to each lottery ticket and may appear in the form of a barcode or other comparable representation. More specifically, the identification data can include information such as the lottery ticket price and the type of the lottery ticket. The scanning device used to scan the identification data can be, but is not limited to, a mobile device or a barcode scanner. The process of receiving identification data is completed when closing the current working shift. As a result, the sales information received at the end of the current working shift is considered to be the starting point of a subsequent working shift. Therefore, any miscalculations that may occur between the current working shift and the subsequent working shift is completely eliminated. In other words, the store owner is guaranteed that the first-remaining ticket of the current working shift is the first available ticket of the subsequent working shift. As an example, consider the first-remaining ticket to be the 10^{th} ticket of the plurality of sequential-ordered lottery tickets. When the identification data for the 10^{th} ticket is received, the present invention identifies that a new working shift is initiated. Therefore, the 10^{th} ticket is considered the starting point of the new working shift. At the conclusion of the new working shift, the present invention receives the identification data for the first-remaining ticket of the new working shift. If the 10^{th} ticket was sold during the new working shift, the first-remaining ticket of the new working shift can be the 5^{th} ticket or any other ticket which is different from the 10^{th} ticket of the plurality of sequential-ordered lottery tickets.

When the identification data of the first-remaining ticket is received, the present invention executes a process of updating the plurality of sequential-ordered lottery tickets. In doing so, the present invention initially compares the identification data to each of the sequential-ordered lottery tickets. The comparison helps in determining a sequential position of the first-remaining lottery ticket amongst the sequential-ordered lottery tickets. Based on the sequential position of the first-remaining lottery ticket, the present invention updates the unsold ticket count and the sold ticket count. Since the sold ticket count and the unsold ticket count is updated for each shift, the store owner gets a clear understanding of the sales of the plurality of sequential-ordered lottery tickets. When the sold ticket count and the unsold ticket count is determined for the current work shift, the present invention records the unsold ticket count and the sold ticket count. The recorded information is saved into a sales log on a secure server with information regarding both the sold tickets and the unsold tickets. In order to generate the time-dependent sales data for the sequential-ordered lottery tickets, the present invention reiterates the process for a plurality of work shifts. In particular, the process of receiving identification data while closing the current work shift, comparing identification data, updating both the sold ticket count and the unsold ticket count, and recording the unsold ticket count and the sold ticket count into the sales log is reiterated for the plurality of work shifts. As a result, the user gets an understanding of the sales of the sequential-ordered lottery tickets. More specifically, the sales data for the roll of lottery tickets is clearly understood. A similar procedure is followed when the time-dependent sales data for a plurality of ticket types needs to be determined. The plurality of ticket types is priced with different monetary amounts. Moreover, the plurality of ticket types is priced with different themed gameplay such that all available ticket types are addressed through the present invention. When the sales data for different ticket types needs to be determined, the user follows a similar procedure. More specifically, the present invention reiterates the process of receiving the identification data, comparing the identification data, updating the ticket counts for the current work shift, and updating the ticket counts for the plurality of work shifts is executed for the plurality of ticket types. Resultantly, the user gets a clear understanding of the sales for the plurality of ticket types which is a plurality of different types of lottery tickets in the preferred embodiment of the present invention.

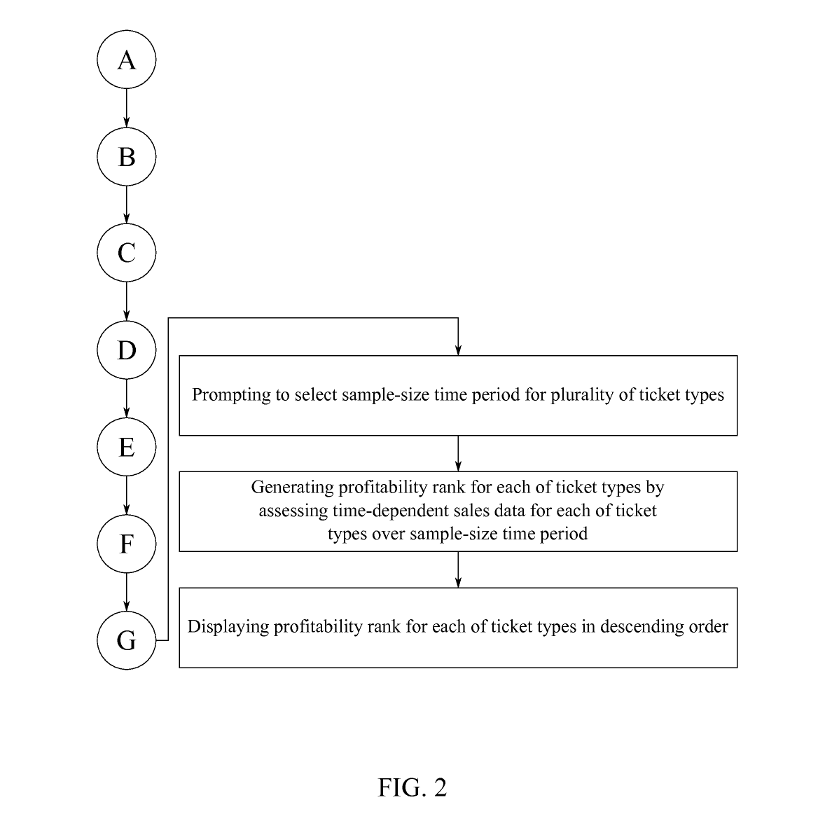

The present invention displays sales information based upon the preference of the user. As an example, the user is allowed view the time-dependent sales data for a shift, a day, a week, or a month. As seen in FIG. 2, in order display time-dependent sales data, the user is initially prompted to select a sample-size time period for the plurality of ticket types. When the sample-size time period is selected, the present invention generates a profitability rank for each of the plurality of ticket types by assessing the time-dependent sales data for each of the plurality of ticket types over the sample-size time period. As an example, if the user selects a week as the sample-size time period, the present invention generates the profitability rank for each of the plurality of lottery ticket types that was sold within the week. The time-dependent sales data is displayed according to the profitability rank for each of the ticket types in a descending order. However, according to user preference, the time-dependent sales data can also be displayed in an ascending order. The profitability rank helps the user understand the most profitable lottery ticket of the plurality of ticket types available. Moreover, the profitability rank can be used to get information on the most-profitable lottery ticket in the store as well as in the state. Knowing the most-profitable lottery ticket and the least-profitable lottery ticket helps the user maximize profit over time.

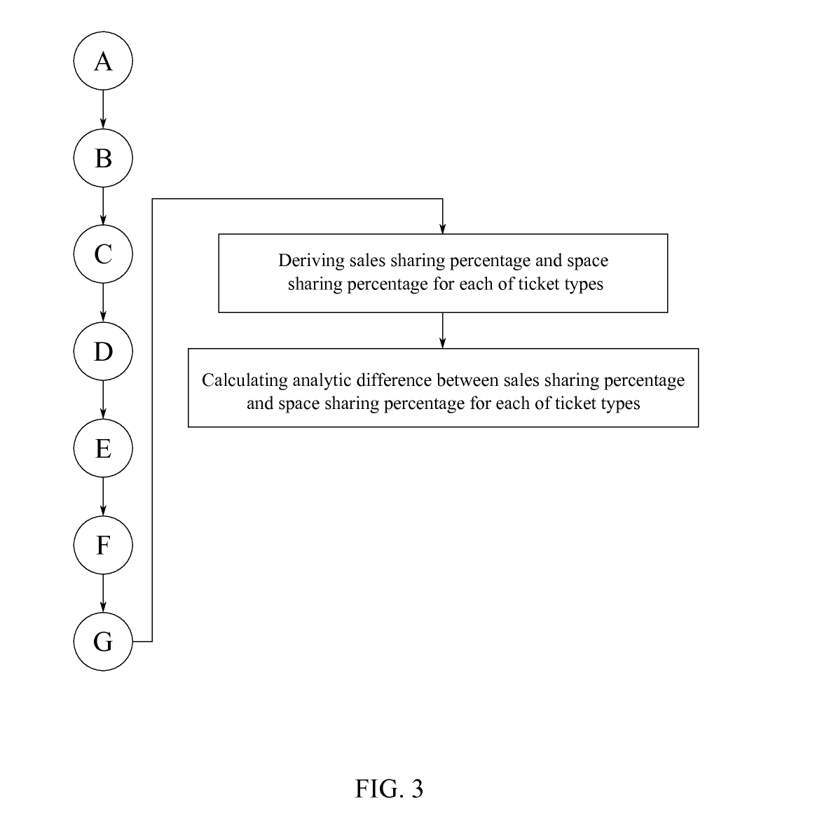

Further elaborating on the time-dependent sales data, the present invention provides information regarding the space occupied by each of the plurality of ticket types and the sales of each of the plurality of ticket types. In order to provide accurate information, an optimal difference range is initially provided by the user. The optimal difference range is based upon the sales data of a particular store and can vary from one store to another. Next, the present invention derives a sales sharing percentage and a space sharing percentage for each of the ticket types as shown in FIG. 3. The sales sharing percentage describes the sales information of a specific type from the ticket types relative to the ticket types available in the store. On the other hand, the space sharing percentage describes the relationship between the space occupied by the specific type to the space occupied by the ticket types available in the store.

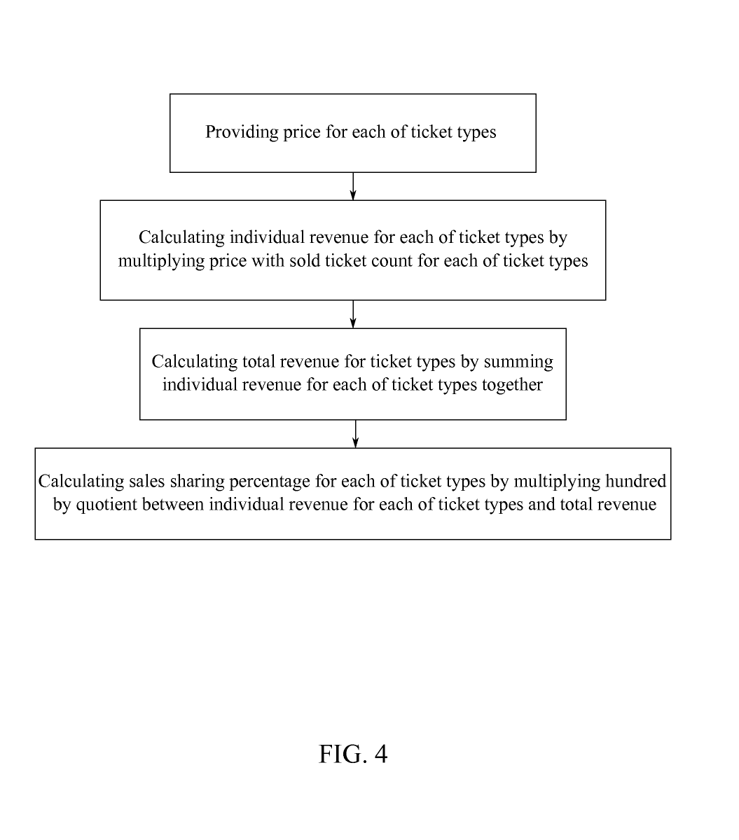

As illustrated in FIG. 4, the sales sharing percentage is calculated by calculating an individual revenue of each of the ticket types. In order to do so, a price for each of the ticket types is initially provided. Using the price, the individual revenue for each of the ticket types is calculated by multiplying the price with the sold ticket count for each of the ticket types. When the individual revenue is calculated, a total revenue is calculated for the ticket types by summing the individual revenue for each of the ticket types together. Next, when both the individual revenue and the total revenue is calculated, the sales sharing percentage for each of the ticket types is calculated by multiplying a hundred by a quotient between the individual revenue for each of the ticket types and the total revenue. As an example, if 20 tickets of a $5 ticket were sold, the individual revenue is $100. On the other hand, if the total revenue from each of the ticket types is $1000, the sales sharing percentage is calculated to be 10%.

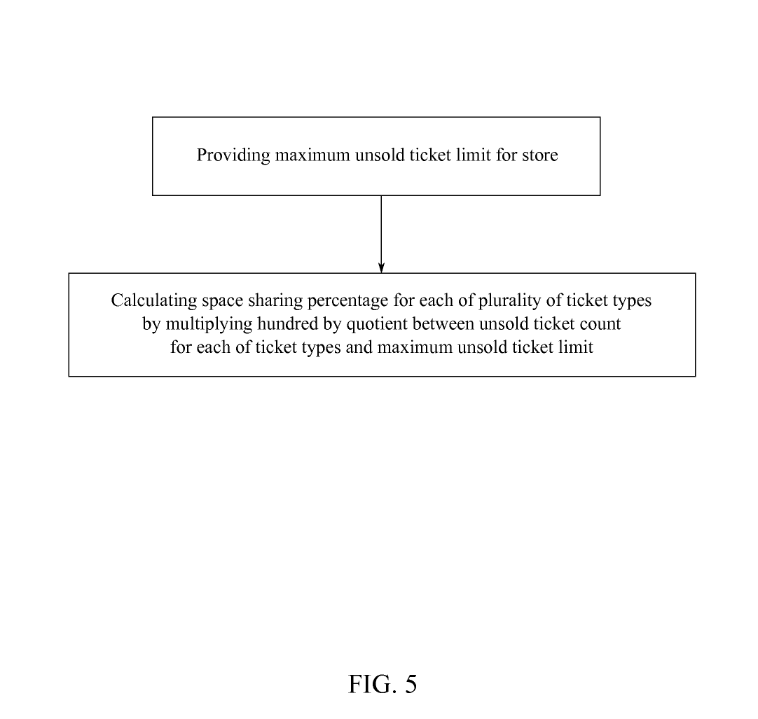

In order to calculate the space sharing percentage, a maximum unsold ticket limit for a store is initially provided as seen in FIG. 5. Using the maximum unsold ticket limit, the space sharing percentage is calculated by multiplying a hundred by a quotient between the unsold ticket count for each of the ticket types and the maximum unsold ticket limit. As an example, if the unsold ticket count is 5 and the maximum unsold ticket limit is 100, the space sharing percentage is calculated to be 5%.

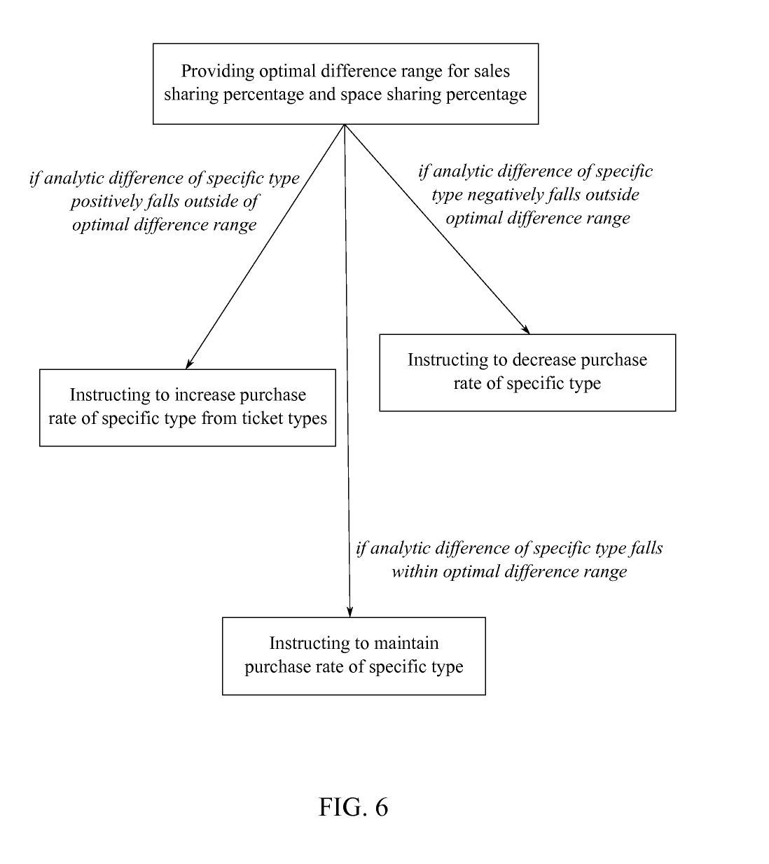

When the sales sharing percentage and the space sharing percentage is determined, the present invention calculates an analytic difference which is representative of both the sales and space of the specific type. Referring back to the previous examples, the analytic difference is calculated to be 5%. In order to utilize the analytic difference on future orders for the plurality of ticket types, the optimal difference range is provided for the sales sharing percentage and the space sharing percentage. Based on the relationship between the analytic difference and the optimal difference range, the present invention instructs the user to increase, maintain, or reduce a purchase rate of the specific type from the ticket types. As illustrated in FIG. 6, if the analytic difference of the specific type falls outside of the optimal difference range, the present invention instructs to increase the purchase rate of the specific type. If the analytic difference of the specific type falls within the optimal different range, the present invention instructs to maintain the purchase rate of the specific type. On the other hand, if the analytic difference negatively falls outside the optimal difference range, the present invention instructs to decrease the purchase rate of the specific type. As a result of utilizing the analytic difference and the optimal difference range, the store can maximize overall profit over a given time period.

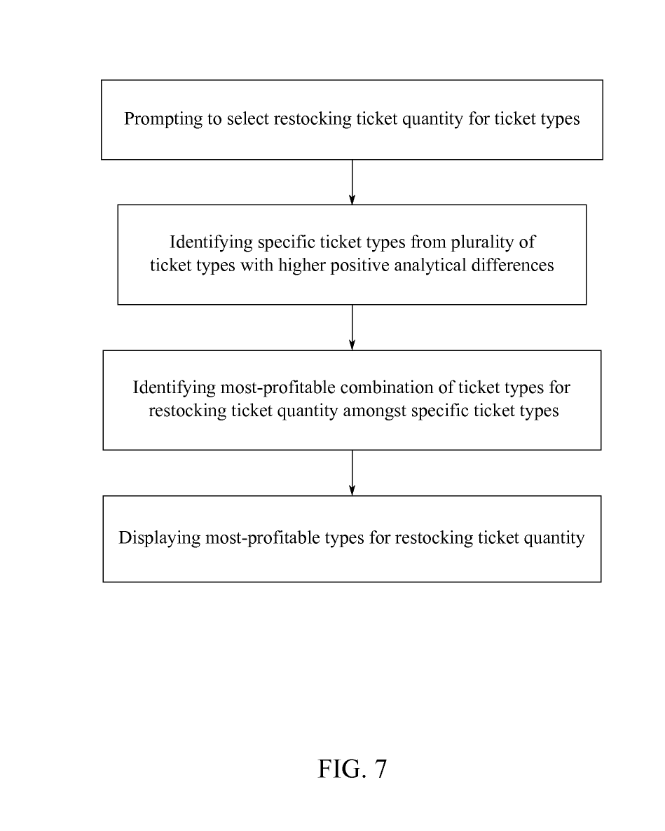

The present invention utilizes the analytic difference to determine the number of lottery ticket boxes that are required for future orders. In the process of doing so, the present invention initially prompts the user to select a restocking ticket quantity for the ticket types as shown in FIG. 7. In the preferred embodiment of the present invention, the number of lottery ticket boxes are referred as the restocking ticket quantity. Next, the present invention identifies specific ticket types from the plurality of ticket types with higher positive analytical differences. The present invention then identifies the most-profitable combination from the specific ticket types with higher analytical differences. Afterwards, the present invention displays the most-profitable types for the restocking ticket quantity. As a result, the user gets a clear understanding of the most-profitable combination of lottery tickets for a selected number of lottery ticket boxes.

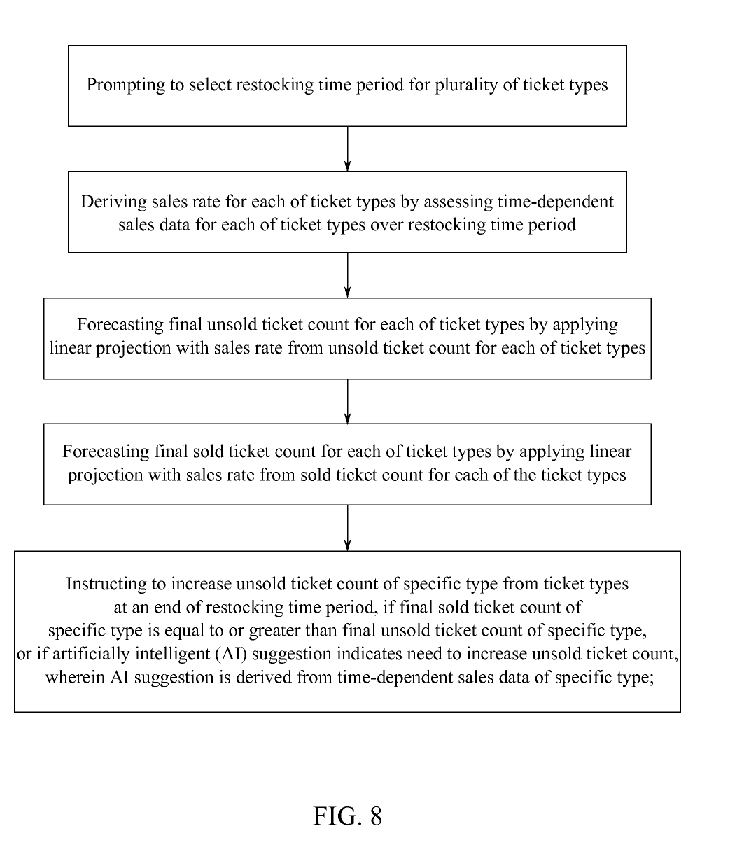

The present invention also aids in the process of determining a future order for the plurality of ticket types. As seen in FIG. 8, the present invention initially prompts the user to select a restocking time period for the plurality of ticket types. The restocking time period can be, but is not limited to, a week or a month. When the restocking time period is selected, the present invention derives a sales rate for each of the ticket types by assessing the time-dependent sales data for each of the ticket types over the restocking time period. Utilizing the sales rate, the present invention forecasts a final unsold ticket count for each of the ticket types by applying a linear projection with the sales rate from the unsold ticket count for each of the ticket types. In particular, the present invention uses the sales rate to determine the final unsold ticket count at an end of the restocking time period. Similarly, the present invention forecasts a final sold ticket count for each of the ticket types by applying a linear projection with the sales rate from the sold ticket count for each of the ticket types. In particular, the sales rate is used to determine the final sold ticket count at the end of the restocking time period. As mentioned before, the final unsold ticket count and the final sold ticket count are utilized to determine future purchases. In doing so, the present invention instructs the user to increase the unsold ticket count of a specific type from the ticket types at the end of the restocking time period if the final sold ticket count is equal to or greater than the final unsold ticket count of the specific type. In other words, the present invention ensures that the store has a sufficient number of tickets to meet the demand at the end of the restocking time period. Furthermore, the present invention also instructs the user to increase the unsold ticket count if an artificially intelligent (AI) suggestion indicates a need to increase the unsold ticket count. The AI suggestion has the ability to indicate the need to increase the unsold ticket count since the AI suggestion is derived from the time-dependent sales data which is based on sales data.

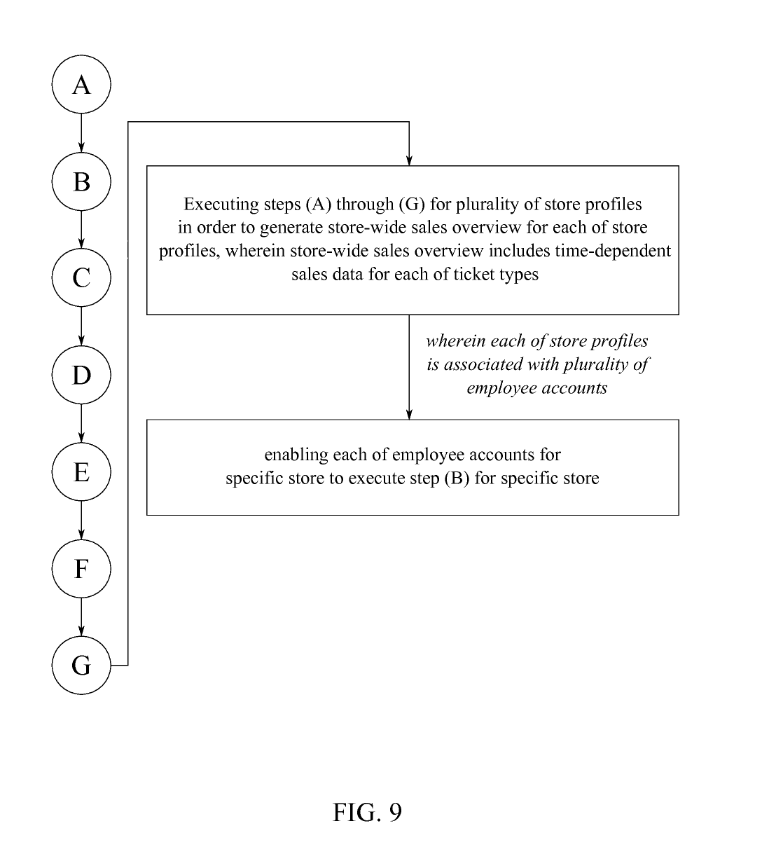

As seen in FIGS. 9-11, the present invention can be used on not only a single store but also on a plurality of stores. In order to do so, the present invention executes the overall process mentioned before for the plurality of store profiles. As a result, the present invention generates a store-wide sales overview for each of the store profiles, wherein the store-wide sales overview includes the time-dependent sales data for each of the ticket types. As previously executed, the present invention prompts the user to select a sample-size time period for the ticket types. When the sample-size time period is selected, the present invention generates a profitability rank for each of the ticket types by assessing the store-wide sales overview for each of the store profiles over the sample-size time period. Next, the present invention displays the profitability rank for each of the ticket types in a descending order. However, the profitability rank for each of the ticket types can also be displayed in an ascending order in another embodiment of the present invention.

As previously discussed, the present invention receives identification data through the scanning device. In the preferred embodiment of the present invention, a plurality of employee accounts associated with each of the store profiles is used to submit information through the scanning device. In order to do so, each of the employee accounts for a specific store is enabled to close the current work shift. When the current work shift is closed, the present invention receives identification data from the first-remaining lottery ticket through the scanning device. The scanning device can be, but is not limited to, a mobile device or a barcode scanner.

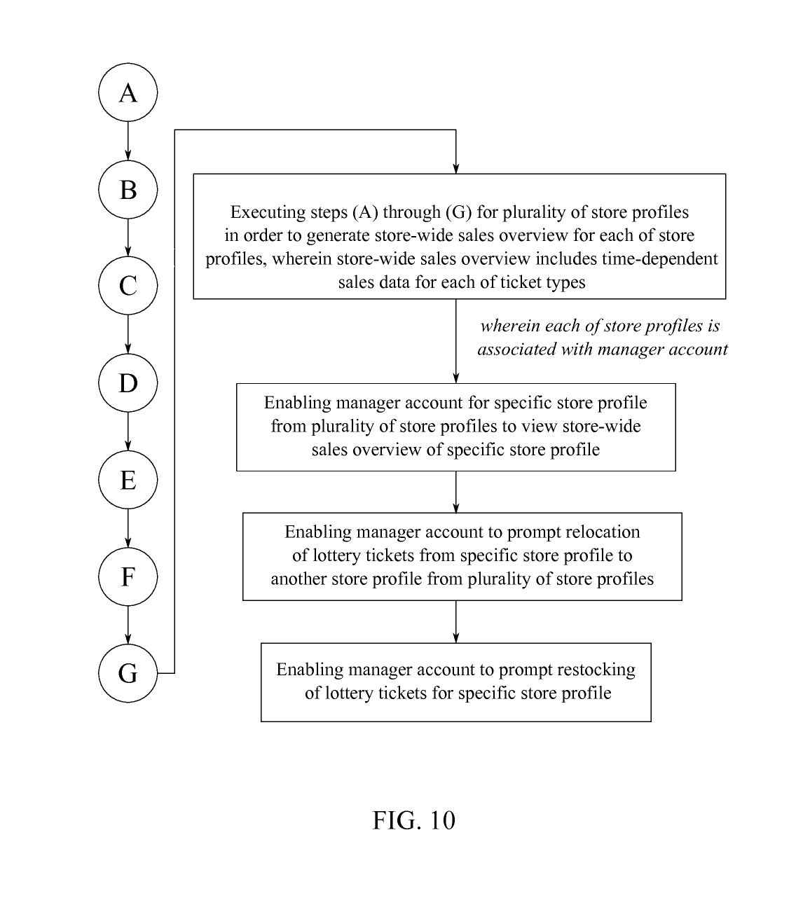

In addition to the plurality of employee accounts, each of the store profiles is associated with a manager account as shown in FIG. 10. In contrast to the plurality of employee accounts, the manager account for a specific store profile from the plurality of store profiles is enabled to view the store-wide sales overview of the specific store profile. Resultantly, the manager account is allowed to make any necessary changes as required. As an example, the present invention enables the manager account to prompt a relocation of lottery tickets from the specific store profile to another store profile from the plurality of store profiles. The relocation of lottery tickets ensures that the store profile has the specific type from the ticket types such that overall profit can be increased. The present invention also enables the manager account to prompt a restocking of lottery tickets for the specific store profile. Restocking also ensures that the store profile has the specific type from the ticket types which yield maximum profit.

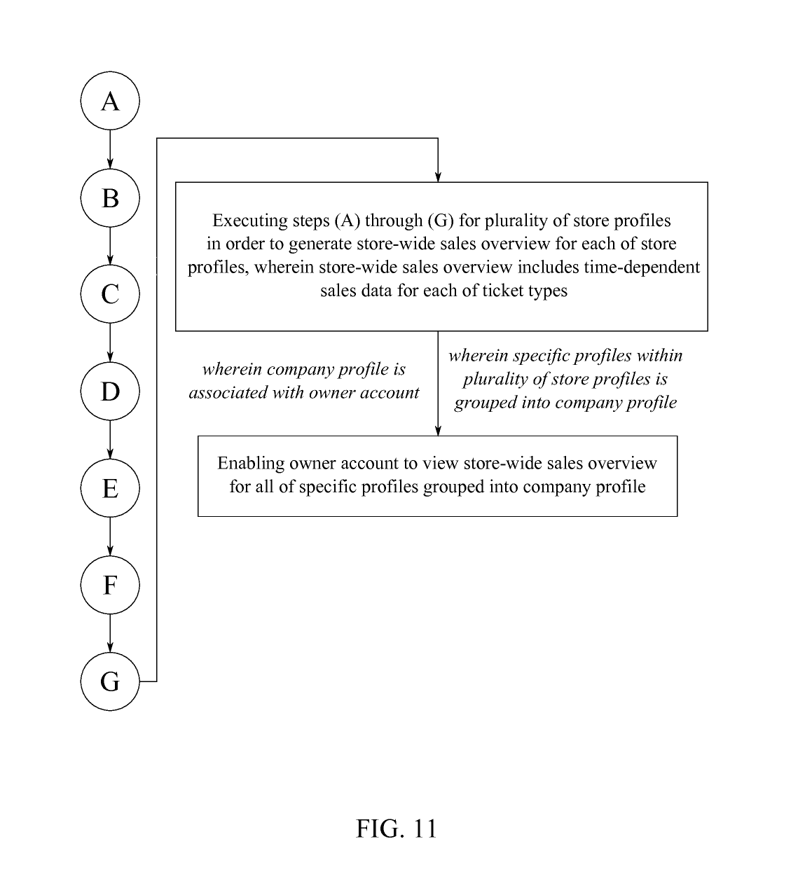

Certain users may own multiple stores. In order to cater multiple stores, specific profiles within the plurality of store profiles is grouped into a company profile as illustrated in FIG. 11. The company profile is associated with an owner account, such that the owner account can access each of the plurality of store profiles grouped within the company profile. In other words, the present invention enables the owner account to view the store-wide sales overview for all of the specific profiles grouped into the company profile.

In utilizing the present invention, the following process flow can be followed. Initially, the identification data for the first-remaining lottery ticket is scanned by the employee account. When the identification data is received, the present invention compares the identification data to each of the sequential-ordered lottery tickets in order to locate the sequential position of the first-remaining ticket. Utilizing the sequential position, the present invention develops the space sharing percentage and the sales sharing percentage. The analytic difference derived from the space sharing percentage and the sales sharing percentage provides information to the manager account regarding the sales of the specific type from the ticket types. Depending on the analytic difference, the manager account can either relocate lottery tickets or restock the specific type. Since the analytic difference is calculated to maximize profit, the owner account is guaranteed to maximize profits with time. Moreover, since all sales information is accessible through the present invention, the owner account is constantly updated regarding the sales of the plurality of store profiles.

Although the invention has been explained in relation to its preferred embodiment, it is to be understood that many other possible modifications and variations can be made without departing from the spirit and scope of the invention as hereinafter claimed.

What is claimed is:

1. A method for tracking lottery sales records by executing computer-executable instructions stored on a non-transitory computer-readable medium, the method comprises the steps of:
(A) providing an unsold ticket count and a sold ticket count for a plurality of sequential-ordered lottery tickets;
(B) closing a current work shift by receiving identification data from a first-remaining lottery ticket through a scanning device;
(C) comparing the identification data to each of the sequential-ordered lottery tickets in order to locate a sequential position of the first-remaining lottery ticket amongst the sequential-ordered lottery tickets;
(D) updating the unsold ticket count and the sold ticket count based on the sequential position of the first-remaining lottery ticket;
(E) recording the unsold ticket count and the sold ticket count into a sales log for the current work shift;
(F) reiterating steps (B) through (E) for a plurality of work shifts in order to generate time-dependent sales data for the sequential-ordered lottery tickets, wherein the time-dependent sales data includes the sales log for each of the work shifts; and
(G) reiterating steps (A) through (F) for a plurality of ticket types in order to collect the time-dependent sales data for each of the ticket types.

2. The method for tracking lottery sales records by executing computer-executable instructions stored on a non-transitory computer-readable medium, the method as claimed in claim 1 comprises the steps of:
prompting to select a sample-size time period for the ticket types;
generating a profitability rank for each of the ticket types by assessing the time-dependent sales data for each of the ticket types over the sample-size time period; and
displaying the profitability rank for each of the ticket types in a descending order.

3. The method for tracking lottery sales records by executing computer-executable instructions stored on a non-transitory computer-readable medium, the method as claimed in claim 1 comprises the steps of:
deriving a sales sharing percentage and a space sharing percentage for each of the ticket types; and
calculating an analytic difference between the sales sharing percentage and the space sharing percentage for each of the ticket types.

4. The method for tracking lottery sales records by executing computer-executable instructions stored on a non-transitory computer-readable medium, the method as claimed in claim 3 comprises the steps of:
providing a price for each of the ticket types;
calculating an individual revenue for each of the ticket types by multiplying the price with the sold ticket count for each of the ticket types;
calculating a total revenue for the ticket types by summing the individual revenue for each of the ticket types together; and
calculating the sales sharing percentage for each of the ticket types by multiplying a hundred by a quotient between the individual revenue for each of the ticket types and the total revenue.

5. The method for tracking lottery sales records by executing computer-executable instructions stored on a non-transitory computer-readable medium, the method as claimed in claim 3 comprises the steps of:
providing a maximum unsold ticket limit for a store; and
calculating the space sharing percentage for each of the plurality of ticket types by multiplying a hundred by a quotient between the unsold ticket count for each of the ticket types and the maximum unsold ticket limit.

6. The method for tracking lottery sales records by executing computer-executable instructions stored on a non-transitory computer-readable medium, the method as claimed in claim 3 comprises the steps of:
providing an optimal difference range for the sales sharing percentage and the space sharing percentage;
instructing to increase a purchase rate of a specific type from the ticket types,
if the analytic difference of the specific type positively falls outside of the optimal difference range;
instructing to maintain the purchase rate of the specific type,
if the analytic difference of the specific type falls within the optimal difference range; and
instructing to decrease the purchase rate of the specific type,
if the analytic difference of the specific type negatively falls outside the optimal difference range.

7. The method for tracking lottery sales records by executing computer-executable instructions stored on a non-transitory computer-readable medium, the method as claimed in claim 3 comprises the steps of:
prompting to select a restocking ticket quantity for the ticket types;
identifying specific ticket types from the plurality of ticket types with higher positive analytical differences;
identifying most-profitable combination of ticket types for the restocking ticket quantity amongst the specific ticket types; and
displaying the most-profitable types for the restocking ticket quantity.

8. The method for tracking lottery sales records by executing computer-executable instructions stored on a non-transitory computer-readable medium, the method as claimed in claim 1 comprises the steps of:
prompting to select a restocking time period for the plurality of ticket types;
deriving a sales rate for each of the ticket types by assessing the time-dependent sales data for each of the ticket types over the restocking time period;
forecasting a final unsold ticket count for each of the ticket types by applying a linear projection with the sales rate from the unsold ticket count for each of the ticket types;
forecasting a final sold ticket count for each of the ticket types by applying a linear projection with the sales rate from the sold ticket count for each of the ticket types; and
instructing to increase the unsold ticket count of a specific type from the ticket types at an end of the restocking time period,
if the final sold ticket count of the specific type is equal to or greater than the final unsold ticket count of the specific type,
or if an artificially intelligent (AI) suggestion indicates a need to increase the unsold ticket count,
wherein the AI suggestion is derived from the time-dependent sales data of the specific type.

9. The method for tracking lottery sales records by executing computer-executable instructions stored on a non-transitory computer-readable medium, the method as claimed in claim 1 comprises the steps of:
executing steps (A) through (G) for a plurality of store profiles in order to generate a store-wide sales overview for each of the store profiles, wherein the store-wide sales overview includes the time-dependent sales data for each of the ticket types.

10. The method for tracking lottery sales records by executing computer-executable instructions stored on a non-transitory computer-readable medium, the method as claimed in claim 9 comprises the steps of:
prompting to select a sample-size time period for the ticket types;
generating a profitability rank for each of the ticket types by assessing the store-wide sales overview for each of the store profiles over the sample-size time period; and
displaying the profitability rank for each of the ticket types in a descending order.

11. The method for tracking lottery sales records by executing computer-executable instructions stored on a non-transitory computer-readable medium, the method as claimed in claim 9 comprises the steps of:
wherein each of the store profiles is associated with a plurality of employee accounts; and
enabling each of the employee accounts for a specific store to execute step (B) for the specific store.

12. The method for tracking lottery sales records by executing computer-executable instructions stored on a non-transitory computer-readable medium, the method as claimed in claim 9 comprises the steps of:
wherein each of the store profiles is associated with a manager account;
enabling the manager account for a specific store profile from the plurality of store profiles to view the store-wide sales overview of the specific store profile;
enabling the manager account to prompt a relocation of lottery tickets from the specific store profile to another store profile from the plurality of store profiles; and
enabling the manager account to prompt a restocking of lottery tickets for the specific store profile.

13. The method for tracking lottery sales records by executing computer-executable instructions stored on a non-transitory computer-readable medium, the method as claimed in claim 9 comprises the steps of:
wherein specific profiles within the plurality of store profiles is grouped into a company profile;
wherein the company profile is associated with an owner account; and
enabling the owner account to view the store-wide sales overview for all of the specific profiles grouped into the company profile.

14. The method for tracking lottery sales records by executing computer-executable instructions stored on a non-transitory computer-readable medium, the method as claimed in claim 1, wherein each of the plurality of ticket types is priced with different monetary amounts.

15. The method for tracking lottery sales records by executing computer-executable instructions stored on a non-transitory computer-readable medium, the method as claimed in claim 1, wherein each of the plurality of ticket types is priced with different themed gameplay.
